(19) United States
(12) Patent Application Publication
(10) Pub. No.: US 2023/0052242 A1
(43) Pub. Date: Feb. 16, 2023

(54) APPARATUSES, COMPUTER-IMPLEMENTED METHODS, AND COMPUTER PROGRAM PRODUCTS FOR ALTERNATIVE PAYMENT TRANSACTIONS

(71) Applicant: Wells Fargo Bank, N.A., San Francisco, CA (US)

(72) Inventors: Ramanathan RAMANATHAN, Bellevue, WA (US); Chris Theodore KALABOUKIS, San Jose, CA (US); Andrew J. GARNER, IV, State Road, NC (US); Abhijit RAO, Irvine, CA (US); Andres J. SAENZ, Redmond, WA (US)

(21) Appl. No.: 16/951,463

(22) Filed: Nov. 18, 2020

(51) Int. Cl. G06Q 40/04; G06Q 20/40; G06Q 20/12; G06Q 20/20; G06Q 20/02; G06Q 40/02

(52) U.S. Cl. CPC G06Q 40/04; G06Q 20/40; G06Q 20/1235; G06Q 20/204; G06Q 20/02; G06Q 40/02

(57) ABSTRACT

A method, apparatus, and computer program product for alternative payment transactions are provided. An example computer-implemented method includes receiving a first request for payment associated with a first transaction that includes one or more first payment parameters and generating an initial payment responsive to the first request for payment based upon the first payment parameters. The computer-implemented method also includes determining first alternative payment data based upon first payment attribute data of a first user associated with the first transaction. The first payment attribute data is associated with non-cash liquid assets of the first user. The computer-implemented method additionally includes modifying the initial payment based upon the first alternative payment data and effectuating the modified initial payment from a first user account associated with the first user in satisfaction of the first transaction. The computer-implemented method may subsequently include modifying the first payment attribute data of the first user.

### TECHNOLOGICAL FIELD

Example embodiments of the present disclosure relate generally to payment transactions and, more particularly, to generating alternative payment data in response to requests for payment.

### BACKGROUND

Customers, businesses, and other parties to a transaction often are presented with a variety of payment mechanisms for completing a financial transaction. For example, a party to a transaction may be able to select a wire transfer, real-time payment, Automated Clearing House (ACH) payment, or the like to provide payment for a transaction. In addition to these cash or credit based forms of payment, customers may also have access to non-cash liquid assets such as stocks, bonds, or the like.

### BRIEF SUMMARY

As described above, parties to a financial transaction (e.g., customers, businesses, financial institutions, and/or other entities) are provided with various options for completing the financial transaction. For example, an application or interface (e.g., point-of-sale device, card reader, etc.) may be presented to a user that allows the user to input information relating to the transaction (e.g., payee, amount, payment type, etc.) in order to complete the transaction between the user and another party to the transaction. In many instances, a customer may simply provide a debit card, credit card, or equivalent mechanism associated with a user's account to complete the transaction. In addition to these cash related payments, customers, businesses, etc. may also have access to other types of non-cash liquid assets (e.g., investment accounts or the like). Although these non-cash liquid assets represent value to the customer or business, traditional systems fail to provide access to these non-cash liquid assets to fund a transaction in real time. Furthermore, conventional attempts to derive value from, for example, investment portfolios rely upon separate transactions for each asset that are time consuming and market dependent.

To solve these issues and others, example implementations of embodiments of the present disclosure may utilize an alternative payment system that generates payments based upon non-cash liquid assets associated with a user. In operation, embodiments of the present disclosure may receive a request for payment associated with a first transaction and generate an initial responsive payment based upon payment parameters of the request for payment. The system may determine alternative payment data based upon payment attribute data of a user for the first transaction that is associated with non-cash liquid assets of the first user and may modify the initial payment based upon the alternative payment data. Additional example embodiments may further identify transactions associated with other users (e.g., at least a second user) and operate to obtain alternative payment data of these users to provide a common benefit to the separate users. For example, two users may each benefit from the combined sale of stocks (e.g., stocks associated with the same entity) to fund a transaction, and the system may minimize the number of transactions (e.g., utilize a single transaction in selling the stocks) to derive value for these non-cash liquid assets. In this way, the inventors have identified that the advent of new payment technologies have created a new opportunity for solutions for providing alternative payment transactions which were historically unavailable. In doing so, such example implementations confront and solve at least two technical challenges: (1) they modify payments to account for alternative payment data in real time, and (2) they minimize storage and computational burdens associated with payment transaction systems.

Systems, apparatuses, computer-implemented methods, and computer program products are disclosed herein for providing alternative payment transactions. With reference to an example computer-implemented method, a method for providing alternative payment transactions may include receiving a first request for payment associated with a first transaction, wherein the first request for payment comprises one or more first payment parameters. The method may further include generating an initial payment responsive to the first request for payment based upon the first payment parameters and determining first alternative payment data based upon first payment attribute data of a first user associated with the first transaction. The first payment attribute data may be associated with non-cash liquid assets of the first user. The method may further include modifying the initial payment based upon the first alternative payment data.

In some embodiments, the method may further include effectuating the modified initial payment from a first user account associated with the first user in satisfaction of the first transaction and modifying the first payment attribute data of the first user.

In some embodiments, the method may further include transmitting a notification to a first user device associated with the first user comprising the modified initial payment.

In some embodiments, determining the first alternative payment data may further include obtaining the first payment attribute data associated with the first user from a payment attribute database and comparing the first payment attribute data with one or more first user payment risk thresholds. The method may further include selecting at least a first non-cash liquid asset from amongst the first payment attribute data as the first alternative payment data in an instance in which the first payment attribute data satisfies the first user payment risk thresholds.

In some further embodiments, the method may include effectuating the modified initial payment by transferring ownership of the first non-cash liquid asset in satisfaction of the first transaction.

In other further embodiments, the method may include identifying a second transaction associated with a second user and obtaining second payment attribute data associated with the second user from the payment attribute database. The method may also include comparing the second payment attribute data with one or more second user payment risk thresholds and selecting at least a second non-cash liquid asset associated with the second user from amongst the second payment attribute data as second alternative payment data in an instance in which the second payment attribute data satisfies the second user payment risk threshold.

In some still further embodiments, the method may include adapting the modified initial payment transaction based upon the second alternative payment data.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart for providing alternative payment transactions, in accordance with some example embodiments described herein.

FIG. 4 illustrates an example flowchart for first user payment attribute determinations, in accordance with some example embodiments described herein.

FIG. 5 illustrates an example flowchart for second user payment attribute determinations, in accordance with some example embodiments described herein.

### DETAILED DESCRIPTION

Some embodiments of the present disclosure will now be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. As used herein, the description may refer to an alternative payment server as an example “apparatus.” However, elements of the apparatus described herein may be equally applicable to the claimed method and computer program product. Thus, use of any such terms should not be taken to limit the spirit and scope of embodiments of the present disclosure.

### Definition of Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used to mean “serving as an example, instance, or illustration.” Any implementation described herein as “example” is not necessarily to be construed as preferred or advantageous over other implementations.

As used herein, the terms “user device,” “mobile device,” “electronic device” and the like refer to computer hardware that is configured (either physically or by the execution of software) to access one or more services made available by an alternative payment server (e.g., apparatus or computing device of the present disclosure) and, among various other functions, is configured to directly, or indirectly, transmit and receive data. Example user devices may include a smartphone, a tablet computer, a laptop computer, a wearable device (e.g., smart glasses, smart watch, or the like), and the like. In some embodiments, a user device may include a “smart device” that is equipped with a chip or other electronic device that is configured to communicate with the apparatus via Bluetooth, NFC, Wi-Fi, 3G, 4G, 5G, RFID protocols, and the like. By way of a particular example, a user device may be a mobile phone equipped with a Wi-Fi radio that is configured to communicate with a Wi-Fi access point that is in communication with the alternative payment server 200 or other computing devices via a network.

As used herein, the term “first user device” refers to a user device as defined above that is associated with a first user which may be in network communication with the alternative payment server, the payment device, and/or the second user device. For example, a first user device may be smartphone or computing device of a user that may request, receive, and/or provide data to or from one of the devices described above. By way of a particular example, a first user device may include a smartphone associated with a payor of a first financial transaction.

As used herein, the term “second user device” refers to a user device as defined above that is associated with a second user which may be in network communication with the alternative payment server, payment device, and/or the first user device. For example, a second user device may be smartphone or computing device of a user that may request, receive, and/or provide data to or from one of the devices described above. By way of a particular example, a second user device may include a smartphone associated with a payor of a second financial transaction.

As used herein, the term “payment device” refers to a user device as defined above that is associated with a vendor, merchant, or payee of a transaction which may be in network communication with the alternative payment server, the first user device, and/or the second user device. For example, a payment device may be card reader, card scanner, or computing device of a merchant that may request, receive, and/or provide data to or from one of the devices described above. By way of a particular example, a payment device may include a card reader of a point-of-sale device associated with a payee of a first financial transaction and/or second financial transaction.

As used herein, the terms “non-cash liquid assets” may refer to any asset or instrument that may be readily converted into cash so as to serve as a cash equivalent with relatively little impact on its value. By way of example, stocks, marketable securities, treasuries, bonds, mutual funds, money-market funds, or the like may be referred to herein as example non-cash liquid assets. Furthermore, “alternative payment data,” as used herein, may refer to data that is generated based upon the non-cash liquid assets of a user. The alternative payment data may include, with reference to an example stock, data indicative of the trading volume, closing price, transaction fee, and/or the like associated with a particular stock. Although described herein with reference to alternative payment data that is associated with a stock as the non-cash liquid asset of the user, the alternative payment data may include data indicative of any feature of the non-cash liquid asset of the user.

As used herein, the term “payment parameter” may refer to any data associated with a transaction. By way of example, payment parameter data may refer to data indicative of the amount, timing, payee, payor, or other payment information associated with a transaction. In some embodiments, payment parameters may further include data associated with an initial payment mechanism by the payee, for example, debit card information, account information, or the like associated with an attempt by the payee to fund payment for a transaction with said payment mechanism.

As used herein, the term “payment attribute data” may refer to data associated with a particular user, user account, or user device. In some example embodiments, payment attribute data may include one or more financial parameters, transaction histories, balances, spending patterns, social media data entries, location data entries, risk tolerances, investment strategies, preferences, or the like of a user. For example, payment attribute data may refer to investment portfolio data, investment risk tolerance, investment strategy, and/or the like associated with a user. The term “payment attribute database” refers to a data structure or repository for storing payment attribute data as described hereafter.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

Having set forth a series of definitions called-upon throughout this application, an example system architecture and example apparatus is described below for implementing example embodiments and features of the present disclosure.

### Device Architecture and Example Apparatus

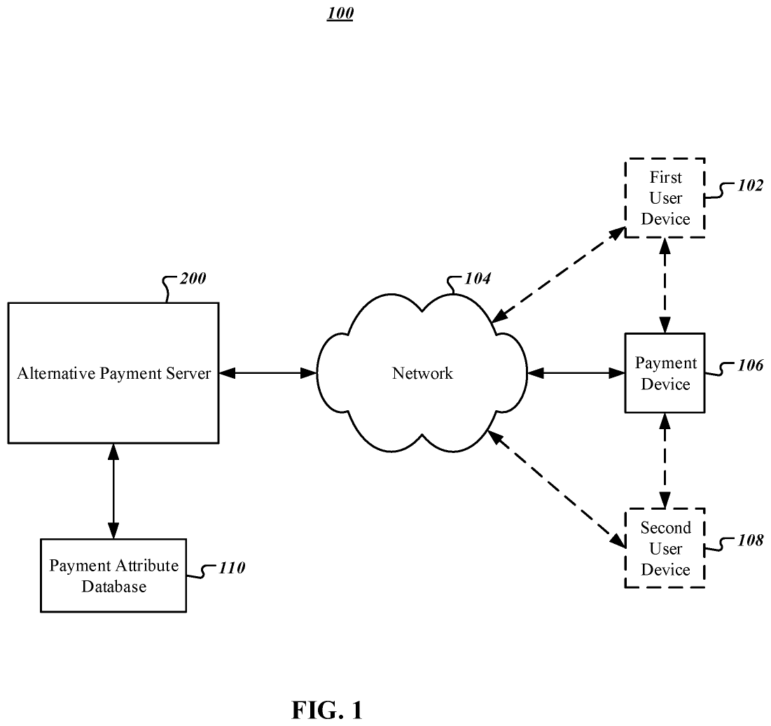

With reference to FIG. 1, an example system 100 is illustrated with an apparatus (e.g., an alternative payment server 200) communicably connected via a network 104 to a payment device 106 and, in some embodiments, a first user device 102 and a second user device 108. The example system 100 may also include an payment attribute database 110 that may be hosted by the alternative payment server 200 or otherwise hosted by devices in communication with the alternative payment server 200.

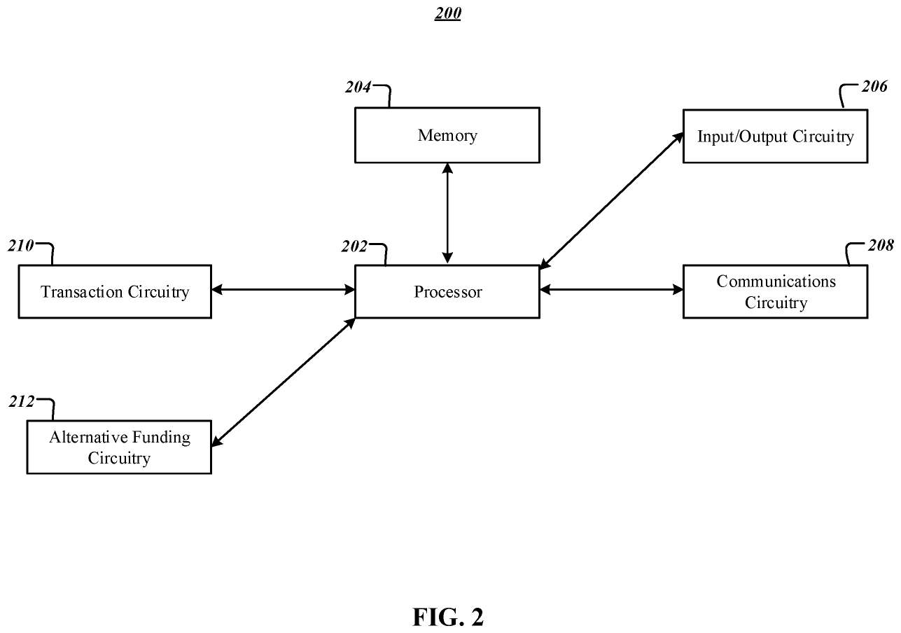

The alternative payment server 200 may include circuitry, networked processors, or the like configured to perform some or all of the apparatus-based (e.g., alternative payment server-based) processes described herein, and may be any suitable network server and/or other type of processing device. In this regard, alternative payment server 200 may be embodied by any of a variety of devices. For example, the alternative payment server 200 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, the alternative payment server 200 may be located remotely from the payment device 106, the first user device 102, the second user device 108, and/or payment attribute database 110, although in other embodiments, the alternative payment server 200 may comprise the payment device 106, the first user device 102, the second user device 108, and/or the payment attribute database 110. The alternative payment server 200 may, in some embodiments, comprise several servers or computing devices performing interconnected and/or distributed functions. Despite the many arrangements contemplated herein, the alternative payment server 200 is shown and described herein as a single computing device to avoid unnecessarily overcomplicating the disclosure.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

The payment device 106 may refer to a device associated with a vendor, merchant, or payee of a transaction as defined above and may be a cellular telephone (e.g., a smartphone and/or other type of mobile telephone), laptop, tablet, electronic reader, e-book device, media device, wearable, smart glasses, smartwatch, card reader, card scanner, point-of-sale device, or any combination of the above. By way of a particular example, a payment device may include a card reader of a point-of-sale device associated with a payee of a first financial transaction and/or second financial transaction and may be configured to, in some embodiments, generate a request for payment associated with a transaction.

The first user device 102 may refer to a user device associated with a first user as defined above and may be a cellular telephone (e.g., a smartphone and/or other type of mobile telephone), laptop, tablet, electronic reader, e-book device, media device, wearable, smart glasses, smartwatch, or any combination of the above. Similarly, the second user device 108 may refer to a user device associated with a second user as defined above and may also be a cellular telephone (e.g., a smartphone and/or other type of mobile telephone), laptop, tablet, electronic reader, e-book device, media device, wearable, smart glasses, smartwatch, or any combination of the above. Although only a first user device 102 and a second user device 108 are illustrated, the example system 100 may include any number of user devices associated with the same user or any number of respective other users.

The payment attribute database 110 may be stored by any suitable storage device configured to store some or all of the information described herein (e.g., memory 204 of the alternative payment server 200 or a separate memory system separate from the alternative payment server 200, such as one or more database systems, backend data servers, network databases, cloud storage devices, or the like provided by another device (e.g., online application or 3^{rd} party provider) or the first or second user devices 102, 108). The payment attribute database 110 may comprise data received from the alternative payment server 200 (e.g., via a memory 204 and/or processor(s) 202), the payment device 106, the first user device 102, or the second user device 108, and the corresponding storage device may thus store this data. As described above, the payment attribute database 110 may exist supported by or otherwise as a part of a financial institution's system in order to provide alternative payment transactions as described hereafter.

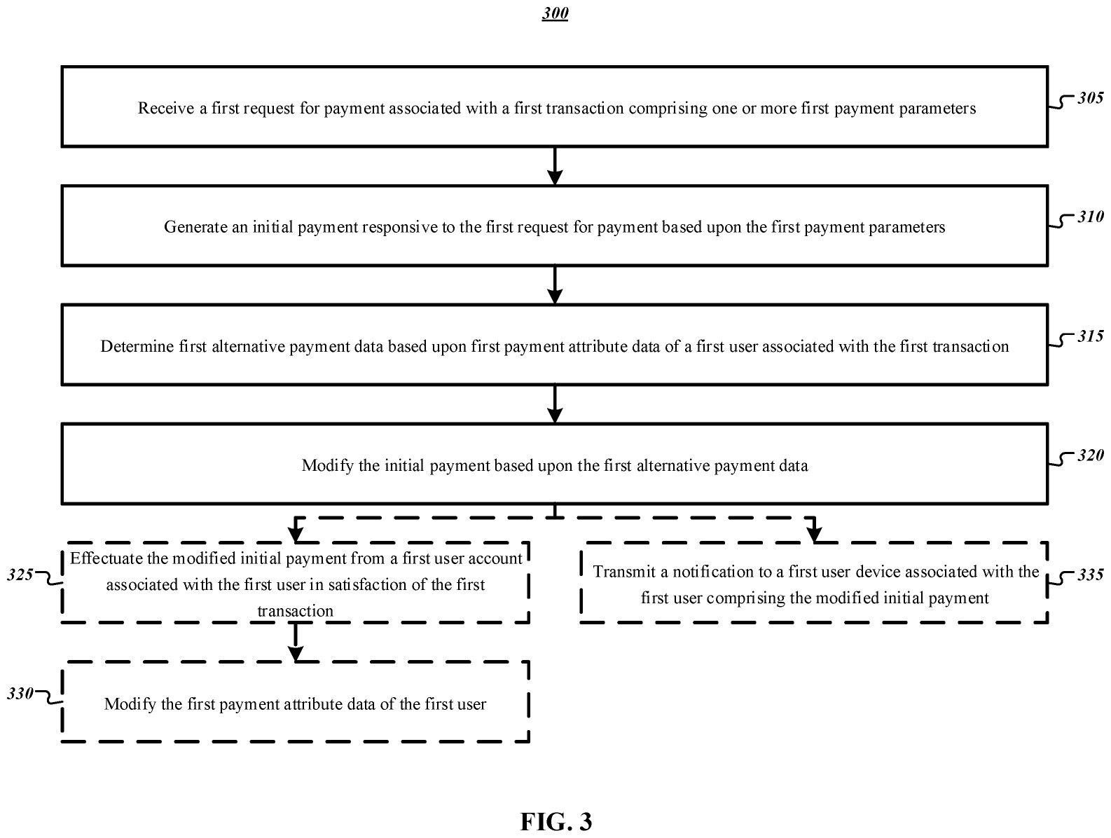

As illustrated in FIG. 2, the alternative payment server 200 may include a processor 202, a memory 204, communications circuitry 208, and input/output circuitry 206. Moreover, the alternative payment server 200 may include transaction circuitry 210 and alternative funding circuitry 212. The alternative payment server 200 may be configured to execute the operations described below in connection with FIGS. 3-5. Although components 202-212 are described in some cases using functional language, it should be understood that the particular implementations necessarily include the use of particular hardware. It should also be understood that certain of these components 202-212 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the alternative payment server 200 may be housed within the payment device 106, the first user device 102, and/or the second user device 108. It will be understood in this regard that some of the components described in connection with the alternative payment server 200 may be housed within one of these devices, while other components are housed within another of these devices, or by yet another device not expressly illustrated in FIG. 1.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the alternative payment server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the alternative payment server 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the alternative payment server 200 to carry out various functions in accordance with example embodiments of the present disclosure.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the alternative payment server, and/or remote or “cloud” processors.

In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

The alternative payment server 200 further includes input/output circuitry 206 that may, in turn, be in communication with processor 202 to provide output to a user and to receive input from a user, user device, or another source. In this regard, the input/output circuitry 206 may comprise a display that may be manipulated by a mobile application. In some embodiments, the input/output circuitry 206 may also include additional functionality such as a keyboard, a mouse, a joystick, a touch screen, touch areas, soft keys, a microphone, a card reader, card scanner, point-of-sale device, speaker, or other input/output mechanisms. The processor 202 and/or user interface circuitry comprising the processor 202 may be configured to control one or more functions of a display through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the alternative payment server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the alternative payment server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

The transaction circuitry 210 includes hardware components designed to generate initial payments responsive to requests for payment. Furthermore, the transaction circuitry 210 may further effectuate modified initial payments from user accounts in satisfaction of an associated transaction. In some instances, the transaction circuitry 210 may effectuate a payment by transferring ownership of the first non-cash liquid asset in satisfaction of the transaction. The transaction circuitry 210 may utilize processing circuitry, such as the processor 202, to perform its corresponding operations, and may utilize memory 204 to store collected information.

The alternative funding circuitry 212 includes hardware components designed to determine alternative payment data based upon payment attribute data of a user associated with the transaction. In particular, the alternative funding circuitry 212 may analyze non-cash liquid assets of a user with associated payment attribute data of the user governing interactions with said non-cash liquid assets in order to determine alternative payment data. Subsequently, the alternative funding circuitry 212 may modify an initial payment based upon the determined alternative payment data. The alternative funding circuitry 212 may utilize processing circuitry, such as the processor 202, to perform its corresponding operations, and may utilize memory 204 to store collected information. In some embodiments, the alternative funding circuitry 212 may leverage artificial intelligence, machine learning, quantum computing, and/or the like as part of determining alternative payment data, modifying initial payment data, etc.

It should also be appreciated that, in some embodiments, the transaction circuitry 210 or the alternative funding circuitry 212 may include a separate processor, specially configured field programmable gate array (FPGA), or application specific interface circuit (ASIC) to perform its corresponding functions.

In addition, computer program instructions and/or other type of code may be loaded onto a computer, processor or other programmable alternative payment server's circuitry to produce a machine, such that the computer, processor other programmable circuitry that execute the code on the machine create the means for implementing the various functions, including those described in connection with the components of alternative payment server 200.

As described above and as will be appreciated based on this disclosure, embodiments of the present disclosure may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Alternative Payment Transactions

FIG. 3 illustrates a flowchart containing a series of operations for alternative payment transactions. The operations illustrated in FIG. 3 may, for example, be performed by, with the assistance of, and/or under the control of an apparatus (e.g., alternative payment server 200), as described above. In this regard, performance of the operations may invoke one or more of processor 202, memory 204, input/output circuitry 206, communications circuitry 208, transaction circuitry 210, and/or alternative funding circuitry 212.

As shown in operation 305, the apparatus (e.g., alternative payment server 200) includes means, such as input/output circuitry 206, communications circuitry 208, or the like, for receiving a first request for payment associated with a first transaction comprising one or more first payment parameters. In some embodiments, a first user, associated with the first user device 102 or otherwise, may interact with a payment device 106 associated with a merchant, vendor, business, or the like. By way of example, a first user may attempt to purchase an item or service offered by a merchant associated with the payment device 106 as a first transaction. In some embodiments as defined above, the payment device 106 may define a card scanner or point-of-sale device associated with the merchant configured to interact with, for example, a credit card, debit card, or the like associated with the first user. Said differently, the first transaction may refer to the scanning of a card associated with the first user at the payment device 106. Although described herein with reference to interaction with a card of the first user, the present disclosure contemplates that the request for payment at operation 305 may be generated by the payment device 106 without interaction with the first user or first user device 102.

The payment device 106 may generate a request for payment that is transmitted to the alternative payment server 200 at operation 305 that includes one or more first payment parameters. As defined above, the first payment parameters may refer to data associated with the first transaction including information regarding the amount, timing, payee, payor, or other payment information associated with the first transaction. In some embodiments in which the payment device 106 generates the request for payment without interaction with a card or device (e.g., first user device 102) of the first user, the first payment parameters may include data associated with the payment amount, payor (e.g., the first user), and/or payment timing. Said differently, the request for payment received at operation 305 may not be associated with a particular mechanism for funding the first transaction by the first user (e.g., not associated with a credit card, debit card, etc. of the first user).

In other embodiments, the payment device 106 may generate the request for payment due to an interaction with a card or device (e.g., first user device 102) of the first user. In such an embodiment, the first payment parameters may include data associated with the payment amount, payor (e.g., the first user), and payment timing as well as data associated with a first user account and/or payment mechanism. Said differently, the request for payment received at operation 305 may be associated with a particular mechanism for funding the first transaction by the first user (e.g., associated with a credit card, debit card, etc. of the first user). Although described herein with reference to a request for payment that is generated by the payment device 106 and received by the alternative payment server 200, the present disclosure contemplates that the request for payment received at operation 305 may be generated by any device (e.g., first user device 102, second user device 108, etc.) communicably coupled with the alternative payment server 200.

Thereafter, as shown in operation 310, the apparatus (e.g., alternative payment server 200) includes means, such as input/output circuitry 206, transaction circuitry 210, or the like, for generating an initial payment responsive to the first request for payment based upon the first payment parameters. As described above, the request for payment received at operation 305 may include one or more first payment parameters associated with the first transaction. In instances in which the first payment parameters are not associated with a payment mechanism of the first user, the transaction circuitry 210 may generate an initial payment responsive to the first request for payment based upon the first payment parameters (e.g., payment amount, payment timing, payee) as further influenced by one or more account preferences associated with the first user. By way of example, an account associated with the first user may, as part of an initial set up procedure or otherwise, define that requests for payment associated with first transactions of the first user be funded by, for example, a checking account associated with the first user. In some instances, the account of the first user may define various thresholds that determine the mechanism for subsequently satisfying the first transaction. For example, the first user may define that requests for payment from a particular device, for a particular amount, at a particular time, etc. are to be funded by associated accounts of the first user. As such, the initial payment generated at operation 310 may be based upon the account information of the first user as well as the first payment parameters of the request for payment.

As described above, the payment device 106 may generate the request for payment due to an interaction with a card or device (e.g., first user device 102) of the first user such that the first payment parameters may include data associated with a first user account and/or payment mechanism. In such embodiments, the transaction circuitry 210 may generate an initial payment responsive to the first request for payment based upon the first payment parameters that includes this payment mechanism or account data. By way of example, the first user may, in attempting to purchase an item or service from merchant associated with the payment device 106, swipe/insert a credit card, debit card, or the like with a card reader/point-of-sale device. The request for payment received at operation 305 may include first payment parameters associated with, for example, the first user's credit card, debit card, etc. As such, the transaction circuitry 210 may, for example generate an initial payment at operation 310 that is funded by an account associated with the credit card, debit card, etc. responsive to the first request for payment. Although described herein with reference to credit cards, debit cards, and the like, the present disclosure contemplates that other type of payment mechanisms (e.g., mobile wallets, real-time payments, or the like) may similarly be used.

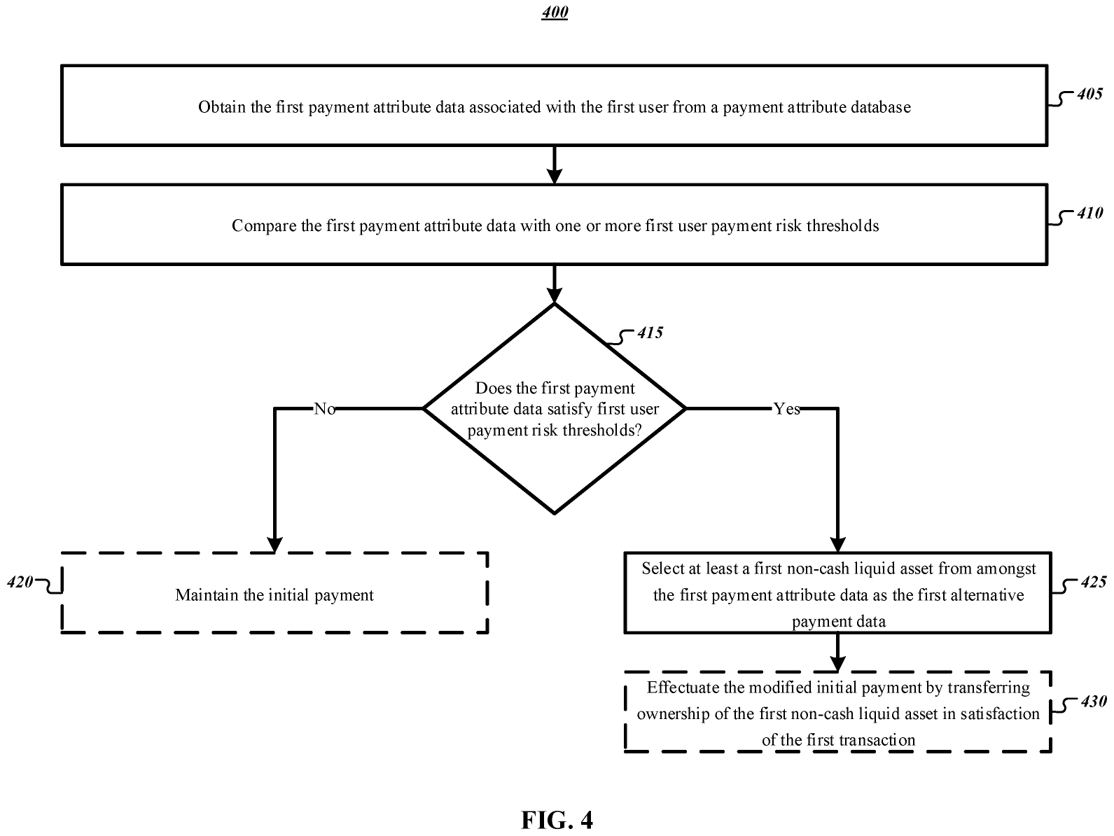

Thereafter, as shown in operation 315, the apparatus (e.g., alternative payment server 200) includes means, such as processor 202, alternative funding circuitry 212, or the like, for determining first alternative payment data based upon first payment attribute data of a first user associated with the first transaction. As described further with reference to FIG. 4 and defined above, the first payment attribute data of the first user is associated with non-cash liquid assets of the first user and management of these non-cash liquid assets of the first user. In some example embodiments, first payment attribute data may include one or more financial parameters, transaction histories, balances, spending patterns, social media data entries, location data entries, risk tolerances, investment strategies, preferences, or the like of the first user. For example, first payment attribute data may refer to investment portfolio data, investment risk tolerance, investment strategy, and/or the like associated with the first user.

As such, the determination at operation 315 may refer to the analysis of first payment attribute data of the first user with various first user payment risk thresholds in order to identify at least a first non-cash liquid asset of the first user for use in satisfying the request for payment. By way of example, the first user may, as defined by the first payment attribute data, be associated with an investment portfolio that includes a plurality of stocks, bonds, or the like associated with one or more companies, entities, etc. The first payment attribute data may define the first user's tolerance for risk associated with these investments as well as instructions for the use of such non-cash liquid assets in satisfying transactions. For example, the first payment attribute data may define risk thresholds that govern which non-cash liquid assets may be used and the circumstances in which these non-cash liquid assets may be used. By way of a more particular example, the first payment attribute data of the first user may define a minimum balance associated with a user's checking account that is tied to a debit card of the user. The first payment attribute data may, for example, provide instructions to use a particular stock to satisfy a request for payment associated with a first transaction in instances in which the cost associated with the first transaction (e.g., defined by the first payment parameters) may cause the checking account with the first user to drop below the minimum balance requirement. Although described herein with reference to a first user payment risk threshold associated with a minimum account balance, the present disclosure contemplates that the first payment attribute data may define any threshold or associated instructions for use of non-cash liquid assets of the first user. Additionally, although referred to herein as payment risk thresholds, the present disclosure contemplates that these thresholds may also refer to various user instructions for determining alternative payment data.

By way of an additional example, the first payment attribute data may, for example, provide instructions regarding the use of any non-cash liquid assets for satisfying the request for payment such that the alternative funding circuitry 212 may select a non-cash liquid asset that maximizes the benefit received by the first user. In particular, the alternative funding circuitry 212 may be configured to analyze the performance of the investment portfolio of the first user, the performance of the market as a whole, the tax implications of any asset sale, and/or the like in order to select a first non-cash liquid asset for satisfying the first request for payment. The alternative funding circuitry 212 may employ any machine learning, artificial intelligence, Monte Carlo simulations, or the like in order to determine a first non-cash liquid asset of the first user. The alternative funding circuitry 212 may determine first alternative payment data based upon this first payment attribute data. The alternative payment data may include, with reference to an example stock, data indicative of the trading volume, closing price, transaction fee, and/or the like associated with a particular stock. Although described herein with reference to alternative payment data that is associated with a stock as the non-cash liquid asset of the user, the alternative payment data may include data indicative of any feature of the non-cash liquid asset of the user.

Thereafter, as shown in operation 320, the apparatus (e.g., alternative payment server 200) includes means, such as the processor 202, the alternative funding circuitry 212, or the like, for modifying the initial payment based upon the first alternative payment data. As described above, the transaction circuitry 210 may generate an initial payment responsive to the first request for payment based upon the first payment parameters at operation 310. At operation 320, the alternative payment data may be used to modify this initial payment by, as described further with reference to FIG. 4, substituting a first non-cash liquid asset to satisfy the first request for payment. By way of continued example, the initial payment generated at operation 310 may, for example, be associated with a checking account of the first user (e.g., an initial payment that uses the funds of the first user's checking account to satisfy the request for payment). The first alternative payment data may be, for example, based upon first payment attribute data that instead selects a first non-cash liquid asset (e.g., a stock of a particular company) to satisfy the first request for payment. Accordingly, the alternative funding circuitry 212 may modify this initial payment to instead use the stock of the first user (e.g., by selling the stock, transferring ownership, etc.) in order to satisfy the first request for payment associated with the first transaction.

In some embodiments, as shown in operation 325, the apparatus (e.g., alternative payment server 200) includes means, such as the processor 202, the communications circuitry 208, the alternative funding circuitry 212, the transaction circuitry 210, or the like, for effectuating the modified initial payment from a first user account associated with the first user in satisfaction of the first transaction. In some embodiments, the alternative payment server 200 may be communicably coupled a first user account associated with the first user device 102 such as instances in which the alternative payment server 200 is associated with a financial institution, investment bank, or banking entity. In such an embodiment, the modified initial payment at operation 320 may be effectuated in that the transaction circuitry 210 of the alternative payment server 200 may cause the sale of the non-cash liquid asset (e.g., stock, bond, etc.) and cause funds derived from such sale to be dispersed from the first user account of the first user and first user deice 102 to the payment device 106 in satisfaction of the fees associated with the first request for payment. As described hereafter with reference to FIG. 4, in some embodiments, the effectuation at operation 325 may instead refer to a transfer of ownership of the non-cash liquid asset to an entity (e.g., business, merchant, etc.) of the payment device 106.

In some further embodiments, as shown in operation 330, the apparatus (e.g., alternative payment server 200) includes means, such as the processor 202, the communications circuitry 208, or the like, for modifying the first payment attribute data of the first user. By way of example, the parameter attribute database 110 may, as described hereafter, include the first payment attribute data of the first user as defined herein. Following use of the first non-cash liquid asset of the first user (e.g., stock, bond, etc.) in satisfaction of the first request for payment associated with the first transaction, the alternative funding circuitry 212 may operate to modify the first payment attribute data of the first user to reflect the use of this asset. Said differently, in some embodiments, the alternative funding circuitry 212 may modify the first payment attribute data to remove ownership of the first non-cash liquid asset by the first user. In some embodiments, the modification at operation 330 may further include data indicative of the use of the first non-cash liquid asset (e.g., modify a data object associated with said asset to associate the asset with the first transaction) and/or may modify the first payment attribute data to indicate the result of the use of the first non-cash liquid asset on the performance of the first user's portfolio. For example, the first payment attribute data may be modified to illustrate that the use of the first non-cash liquid asset of the first user instead of the initial payment generated at operation 310 resulted in a tax benefit to the first user, an increase in the performance of the first user's portfolio, a net-positive impact on the first user's cash flow, and/or the like.

In some embodiments, as shown in operation 335, the apparatus (e.g., alternative payment server 200) includes means, such as the processor 202, the communications circuitry 208, or the like, for transmitting a notification to a first user device 102 associated with the first user comprising the modified initial payment. By way of example, the alternative payment server 200 may determine a modified initial payment based upon the first alternative payment data. At operation 335, the alternative payment server 200 may notify the first user via the first user device 102 of the modified initial payment. The notification may identify the initial payment, the modified initial payment, and/or the first alternative payment data (e.g., the selected first non-cash liquid asset) for review and approval by the first user. Said differently, the transmission provided at operation 335 may operate to allow the first user to confirm that the modified initial payment matches the first payment attribute data of the first user.

Turning next to FIG. 4, a flowchart is shown for first payment attribute determinations. The operations illustrated in FIG. 4 may, for example, be performed by, with the assistance of, and/or under the control of an apparatus (e.g., alternative payment server 200), as described above. In this regard, performance of the operations may invoke one or more of processor 202, memory 204, input/output circuitry 206, communications circuitry 208, transaction circuitry 210, and/or alternative funding circuitry 212.

As shown in operation 405, the apparatus (e.g., alternative payment server 200) includes means, such as input/output circuitry 206, transaction circuitry 210, or the like, for obtaining the first payment attribute data associated with the first user from a payment attribute database 110. As described above, the payment attribute database may define a repository for storing various payment attributes associated with respective users. At operation 405, the communications circuitry 208 may, in some embodiments, query the payment attribute database 110 in order to obtain the first payment attribute data associated with the first user. Although described herein with reference to a query by the communications circuitry 208, the present disclosure contemplates that, in some embodiments, the alternative payment server 200 may comprise the payment attribute database (e.g., stored in memory 204 or otherwise). Similarly, in some embodiments, the alternative payment server 200 may obtain the first payment attribute data associated with the first user as part of the request for payment described above with reference to operation 305.

As shown in operations 410 and 415, the apparatus (e.g., alternative payment server 200) includes means, such as input/output circuitry 206, transaction circuitry 210, or the like, for comparing the first payment attribute data with one or more first user payment risk thresholds. As described above, the first payment attribute data of the first user is associated with non-cash liquid assets of the first user and management of these non-cash liquid assets of the first user. For example, first payment attribute data may include one or more financial parameters, transaction histories, balances, spending patterns, social media data entries, location data entries, risk tolerances, investment portfolio data, investment risk tolerance, investment strategy, and/or the like associated with the first user.

As illustrated in FIG. 4, in some embodiments, the first payment attribute data may define first user payment risk thresholds that govern which non-cash liquid assets may be used and the circumstances in which these non-cash liquid assets may be used. By way of example, the first user may define a first user payment risk threshold associated with minimum profit realization requirement for the use of a first non-cash liquid asset (e.g., the use of any stock in the first user's investment portfolio). The first payment attribute data may at operations 410 and 415, for example, compare first payment attribute data associated with a particular stock of Company A with the first payment risk thresholds to determine if this first payment attribute data (e.g., the use of the stock of Company A) satisfies the first payment risk threshold (e.g., exceeds a minimum profit realization requirement). By way of a more particular example, the first user payment risk threshold may require that the sale (e.g., or transfer of ownership) of any stock for Company A owned by the first user must realize at least a 6% return on investment (ROI). As such, the alternative fund circuitry 212 may compare the expected profit associated with the sale of the stock of Company A and, in an instance in which the realized profit exceeds 6% ROI, may determine that the first payment attribute data satisfies the first user payment risk threshold. In an instance in which the realized profit fails to exceed 6% ROI, the alternative funding circuitry 212 may determine that the first payment attribute data fails to satisfy the first user payment risk threshold.

The comparisons performed at operations 410 and 415 may be iteratively performed to account for any number of non-cash liquid assets of the first user. By way of example, the first payment attribute data may define a portion of the first user's investment portfolio for comparison at operation 410 and 415 or may, alternatively, allow the alternative funding circuitry 212 to compare each non-cash liquid asset (e.g., first payment attribute data) with the first user payment risk thresholds to identify one or more non-cash liquid assets for use as the first alternative payment data. Although described herein with reference to an example first user payment risk threshold related to minimum profit realization or ROI, the present disclosure contemplates that any metric, feature, parameter, etc. associated with the use of any non-cash liquid asset of the first user may be used by the alternative funding circuitry 212 without limitation. For example, the first user payment risk thresholds may define a required number of stocks, a required timing for the sale of stocks, the type or industry, and/or the like associated with a particular company or collections of companies, assets, etc. These first user payment risk thresholds may further be dynamically modified by the alternative funding circuitry 212 based upon prior operations of the alternative payment server 200, changes in the first payment attribute data, and/or the like.

In an instance in which the first payment attribute data fails to satisfy the first user payment risk thresholds, as shown in operation 420, the apparatus (e.g., alternative payment server 200) includes means, such as input/output circuitry 206, transaction circuitry 210, or the like, for maintaining the initial payment. By way of example, the alternative funding circuitry 212 may perform the comparison described above with reference to operations 410 and 415 and, in some embodiments, fail to select a first non-cash liquid asset (e.g., first payment attribute data) that satisfies the first user payment risk thresholds. In some instances, the use of a first non-cash liquid asset may result in a negative performance of the first user's investment portfolio. In other instances, the use of funds associated with the initial payment (e.g., credit card, debit card, or the like) satisfy the associated first payment risk thresholds of the first user such that the use of a non-cash liquid asset is unnecessary.

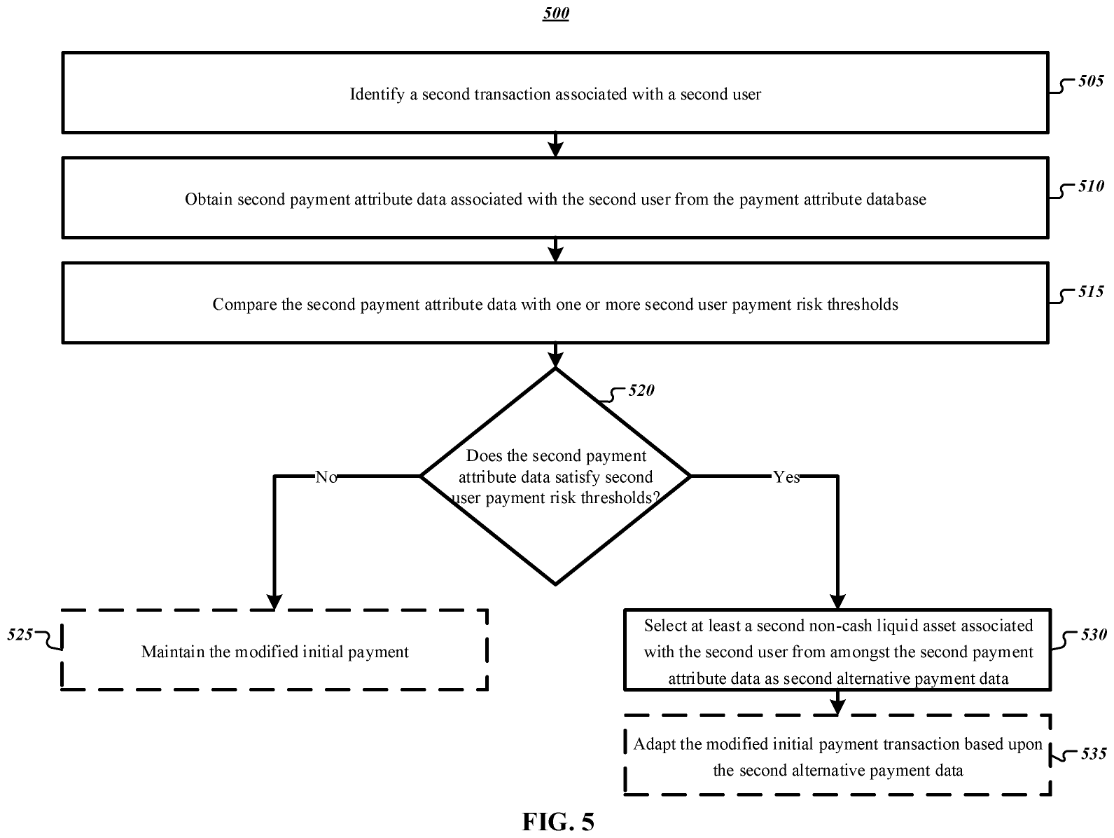

In an instance in which the first payment attribute data satisfies the first user payment risk thresholds, as shown in operation 425, the apparatus (e.g., alternative payment server 200) includes means, such as input/output circuitry 206, transaction circuitry 210, or the like, for selecting at least a first non-cash liquid asset from amongst the first payment attribute data as the first alternative payment data. As described above, the alternative funding circuitry 212 may select a first non-cash asset (e.g., stock, bond, etc.) from amongst the first payment attribute data as the first alternative payment data. By way of example, a first stock of a Company A may, via the comparisons at operations 410 and 415, be selected as the first non-cash liquid asset due to the sale or transfer of this first stock of Company A satisfying one or more first user payment risk thresholds. In an instance in which more than one non-cash liquid asset satisfy the first user payment risk thresholds, the alternative funding circuitry 212 may perform one or more market analyses, comparisons, notify the user for confirmation, or the like to select the first non-cash liquid asset at operation 420. In some instances as described hereafter with reference to FIG. 5, the alternative funding circuitry 212 may leverage transactions by other users (e.g., at least a second user) in order to select a first non-cash liquid asset.

In some embodiments, as shown in operation 430, the apparatus (e.g., alternative payment server 200) includes means, such as the processor 202, the communications circuitry 208, the alternative funding circuitry 212, the transaction circuitry 210, or the like, for effectuating the modified initial payment by transferring ownership of the first non-cash liquid asset in satisfaction of the first transaction. By way of example, in some embodiments, the alternative funding circuitry 212 may be configured to transfer ownership from the first user to a merchant, business, or other entity associated with the request for payment. The alternative payment server 200 may, for example, be formed as part of a financial institution, investment bank, banking entity, or the like that may be configured to transfer ownership of one or more non-cash liquid assets. In such an embodiment, the merchant, business, etc. associated with the payment device 106 may, as part of an initial set up procedure or otherwise, confirm that the merchant, business, etc. will receive ownership of non-cash liquid assets in satisfaction for requests for payment. In some embodiments, the alternative payment server 200 may transmit a notification to the payment device 106 requesting confirmation of a transfer of ownership from the first user to the merchant, business, etc. in satisfaction of the first transaction (e.g., responsive to the request for payment).

In some embodiments, the transfer of ownership of one or more non-cash liquid assets may include one or more intermediary steps or transfer operations. In some instances, for example, applicable industry regulations associated with particular non-cash liquid assets may require mandatory holding periods such that the assets may, as part of the transfer of ownership, be held, located, etc. in an escrow or similar mechanism for a time period set by regulation. In some instances, the alternative payment server 200 may leverage artificial intelligence, machine learning, and/or quantum computing in selecting one or more non-cash liquid assets for payment (e.g., for determining alternative payment data). As part of leveraging these technologies, a transaction may be temporarily funded, such as by a financial institution associated with the server 200, while alternative payment data is determined (e.g., the non-cash liquid asset is selected) and held by an escrow or similar mechanism. By way of a particular example, during determination of alternative payment data as described above, the server 200 may leverage a distributed ledger or the like with smart contracts that initiate and/or confirm a short term loan for the required hold period. In this way, a transaction may be immediately funded by the server 200 while smart contracts are executed in parallel such that the loan triggers payment and execution of the sale and then the expiration of the hold triggers the actual settlement of the funds, the clearing of the loan, and the recording of asset transfer. In some instances, ownership of the non-cash liquid assets may be fractional in which multiple owners of a single or multiple, for example, shares of stock are aggregated as part of the operations described herein.

Turning next to FIG. 5, a flowchart is shown for second payment attribute determinations. The operations illustrated in FIG. 5 may, for example, be performed by, with the assistance of, and/or under the control of an apparatus (e.g., alternative payment server 200), as described above. In this regard, performance of the operations may invoke one or more of processor 202, memory 204, input/output circuitry 206, communications circuitry 208, transaction circuitry 210, and/or alternative funding circuitry 212.

As described above, in some embodiments, the alternative payment server 200 may be configured to leverage transactions by other users (e.g., at least a second user) in order to improve the selection of the first non-cash liquid asset. By way of example, the alternative payment server 200 may be associated with a financial institution, investment bank, banking entity, or the like such that the server 200 may receive requests for payment associated with a plurality of transactions between a plurality of payment devices and a plurality of users. As such, the alternative payment server 200 may be configured to derive investment performance related benefits for each of the plurality of users by combining, batching, etc. transactions associated with similar non-cash liquid assets. As described hereafter, the server 200 may, in response to a request for payment associated with a second transaction between a second user and a payment device, identify a second non-cash liquid asset that, in combination of the selection of the first non-cash liquid asset, reduces the transaction costs or processing fees associated with the first user and the second user, improves the investment performance of both the first user and the second user, or provides any other benefit otherwise unavailable to the first user and second user. Said differently, various thresholds described herein may be met by the combined first user and second user that would otherwise not be met by these users alone. In doing so, the alternative payment server 200 may further minimize storage and computational burdens associated with payment transaction systems by dynamically combining distinct transactions.

As shown in operations 505 and 510, the apparatus (e.g., alternative payment server 200) includes means, such as input/output circuitry 206, transaction circuitry 210, or the like, for identifying a second transaction associated with a second user and obtaining second payment attribute data associated with the second user from the payment attribute database. Similar to the first transaction, the alternative payment server 200 may be configured to receive a second request for payment or otherwise identify a second transaction via communications between the server 200 and the second user device 108 and/or the payment device 106. As described above, the payment attribute database may define a repository for storing various payment attributes associated with respective users. At operation 510, the communications circuitry 208 may, in some embodiments, query the payment attribute database 110 in order to obtain the second payment attribute data associated with the second user. Although described herein with reference to a query by the communications circuitry 208, the present disclosure contemplates that, in some embodiments, the alternative payment server 200 may comprise the payment attribute database (e.g., stored in memory 204 or otherwise). Similarly, in some embodiments, the alternative payment server 200 may obtain the second payment attribute data associated with the second user as part of a second request for payment.

As shown in operations 515 and 520, the apparatus (e.g., alternative payment server 200) includes means, such as input/output circuitry 206, transaction circuitry 210, or the like, for comparing the second payment attribute data with one or more second user payment risk thresholds as described above with reference to FIG. 4. Similarly, the second payment attribute data of the second user is associated with non-cash liquid assets of the second user and management of these non-cash liquid assets of the second user. The second payment attribute data may define second user payment risk thresholds that govern which non-cash liquid assets may be used and the circumstances in which these non-cash liquid assets may be used.

By way of example, the second user may define a second user payment risk threshold associated with minimum profit realization requirement for the use of a second non-cash liquid asset (e.g., the use of any stock in the second user's investment portfolio). The second payment attribute data may at operations 515 and 520, for example, compare second payment attribute data associated with a particular stock of Company A with the second payment risk thresholds to determine if this second payment attribute data (e.g., the use of the stock of Company A) satisfies the second payment risk threshold (e.g., exceeds a minimum profit realization requirement or the like). The comparisons performed at operations 515 and 520 may be iteratively performed to account for any number of non-cash liquid assets of the second user. In the embodiment of FIG. 5, however, the comparisons at operations 515 and 520 may further account for the determinations regarding to first non-cash liquid assets of the first user described above.

With continued reference to FIG. 5, the second payment attribute data may, when considered alone, fail to satisfy the second user payment risk thresholds. By way of example, the second user payment risk thresholds may require that the transaction costs associated with the sale of a non-cash liquid asset do not exceed a user-defined value. Said differently, the second user may ensure that the sale of the second non-cash liquid asset does not result in a transaction cost that exceeds the benefit received by the second user by relying upon non-cash liquid assets. When considered alone, the second payment attribute data may fail to satisfy such a second user payment risk threshold related to transaction costs. When aggregated with the sale of the first user non-cash liquid asset, however, the total transaction cost may, in some embodiments, be shared by both the first user and the second user such that the second payment attribute data now satisfies the second user payment risk threshold. In some still further embodiments, the first non-cash liquid asset and the second non-cash liquid asset may relate to the same entity (e.g., stock of Company A) such that transaction costs may be further reduced. Although described herein with reference to a first non-cash liquid asset and a second non-cash liquid asset, the present disclosure contemplates that the alternative payment server 200 may consider the non-cash liquid assets of a plurality of users and associated transactions in order to further improve the use of non-cash liquid assets by each of these users.

In an instance in which the second payment attribute data fails to satisfy the second user payment risk thresholds, as shown in operation 525, the apparatus (e.g., alternative payment server 200) includes means, such as input/output circuitry 206, transaction circuitry 210, or the like, for maintaining the modified initial payment. By way of example, in some instances, the aggregation of multiple transactions, users, and non-cash liquid assets may not result in a net benefit to one of the users (e.g., the first user). In such an embodiment, the alternative payment server may maintain the modified initial payment described above with reference to FIG. 3.

In an instance in which the second payment attribute data satisfies the second user payment risk thresholds, as shown in operation 530, the apparatus (e.g., alternative payment server 200) includes means, such as input/output circuitry 206, transaction circuitry 210, or the like, for selecting at least a second non-cash liquid asset from amongst the second payment attribute data as the second alternative payment data. As described above, the alternative funding circuitry 212 may select a second non-cash asset (e.g., stock, bond, etc.) from amongst the second payment attribute data as the second alternative payment data. By way of example, a second stock of a Company A may, via the comparisons at operations 515 and 520, be selected as the second non-cash liquid asset due to the sale or transfer of this second stock of Company A satisfying one or more second user payment risk thresholds. As described above, this selection may result in a net benefit to both the first user and the second user.

In some embodiments, as shown in operation 535, the apparatus (e.g., alternative payment server 200) includes means, such as input/output circuitry 206, transaction circuitry 210, or the like, for adapting the modified initial payment transaction based upon the second alternative payment data. As described above with reference to operation 320, the transaction circuitry 210 may generate a modified initial payment responsive to the first request that selects a first non-cash liquid asset (e.g., a stock of a particular company) to satisfy the first request for payment. In response to the operations of FIG. 5, however, the alternative funding circuitry 212 may adapt this modified initial payment based upon the selection of the second non-cash liquid asset of the second user. In some instances, this adaptation may refer to the selection of a different non-cash liquid asset as the first alternative payment data (e.g., a stock associated with Company B). In other embodiments, this adaptation may refer to the selection of the same non-cash liquid asset as the first alternative payment data (e.g., a stock associated with Company A) but with additional benefits offered by the aggregation of the first and second non-cash liquid assets. In doing so, the alternative payment server may not only provide investment or cost benefits to the first and second users, the alternative payment system may further reduce the number of transactions effectuated by the system resulting in reduced memory and computational burdens on the system.

As described above, various technical challenges are surmounted via technical solutions contemplated herein. For instance, example implementations of embodiments of the present disclosure utilize an alternative payment system that generates payments based upon non-cash liquid assets associated with a user. In operation, embodiments of the present disclosure may receive a request for payment associated with a first transaction and generate an initial responsive payment based upon payment parameters of the request for payment. The system may determine alternative payment data based upon payment attribute data of a user for the first transaction that is associated with non-cash liquid assets of the first user and may modify the initial payment based upon the alternative payment data. Additional example embodiments may further identify transactions associated with other users (e.g., at least a second user) and operate to obtain alternative payment data of these users to provide a common benefit to the separate users. For example, two users may each benefit from the combined sale of stocks (e.g., stocks associated with the same entity) to fund a transaction, and the system may minimize the number of transactions (e.g., utilize a single transaction in selling the stocks) to derive value for these non-cash liquid assets. In this way, the inventors have identified that the advent of new payment technologies have created a new opportunity for solutions for providing accurate payment and payee determinations which were historically unavailable. In doing so, such example implementations confront and solve at least two technical challenges: (1) they modify payments to account for alternative payment data in real time, and (2) they minimize storage and computational burdens associated with payment transaction systems.

FIGS. 3-5 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the alternative payment server 200 and executed by a processor 202 of the alternative payment server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### CONCLUSION

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A computer-implemented method for alternative payment transactions, the method comprising:
receiving a first request for payment associated with a first transaction, wherein the first request for payment comprises one or more first payment parameters;
generating an initial payment responsive to the first request for payment based upon the first payment parameters;
determining first alternative payment data based upon first payment attribute data of a first user associated with the first transaction, wherein the first payment attribute data is associated with non-cash liquid assets of the first user and the first payment attribute data provides one or more instructions regarding the selection of non-cash liquid assets associated with the first user;
modifying the initial payment based upon the first alternative payment data, wherein modifying the initial payment comprises selection of at least a first non-cash liquid asset as defined by the first payment attribute data; and
effectuating the modified initial payment by transferring ownership of the at least first non-cash liquid asset directly to an entity associated with the request for payment in satisfaction of the first transaction.

2. (canceled)

3. The computer-implemented method according to claim 1, further comprising transmitting a notification to a first user device associated with the first user comprising the modified initial payment.

4. The computer-implemented method according to claim 1, wherein determining the first alternative payment data further comprises:
obtaining the first payment attribute data associated with the first user from a payment attribute database;
comparing the first payment attribute data with one or more first user payment risk thresholds; and
selecting at least the first non-cash liquid asset from amongst the first payment attribute data as the first alternative payment data in an instance in which the first payment attribute data satisfies the first user payment risk thresholds.

5. (canceled)

6. The computer-implemented method according to claim 4, further comprising:
identifying a second transaction associated with a second user;
obtaining second payment attribute data associated with the second user from the payment attribute database;
comparing the second payment attribute data with one or more second user payment risk thresholds; and
selecting at least a second non-cash liquid asset associated with the second user from amongst the second payment attribute data as second alternative payment data in an instance in which the second payment attribute data satisfies the second user payment risk threshold.

7. The computer-implement method according to claim 6, further comprising adapting the modified initial payment transaction based upon the second alternative payment data.

8. An apparatus for alternative payment transactions, the apparatus comprising:
communications circuitry configured to receive a first request for payment associated with a first transaction, wherein the first request for payment comprises one or more first payment parameters;
transaction circuitry configured to generate an initial payment responsive to the first request for payment based upon the first payment parameters; and
alternative funding circuitry configured to:
determine first alternative payment data based upon first payment attribute data of a first user associated with the first transaction, wherein the first payment attribute data is associated with non-cash liquid assets of the first user and the first payment attribute data provides one or more instructions regarding the selection of non-cash liquid assets associated with the first user;
modify the initial payment based upon the first alternative payment data, wherein modifying the initial payment comprises selection of at least a first non-cash liquid asset as defined by the first payment attribute data; and
effectuate the modified initial payment by transferring ownership of flail the at least first non-cash liquid asset directly to an entity associated with the request for payment in satisfaction of the first transaction.

9. (canceled)

10. The apparatus according to claim 8, wherein the communications circuitry is further configured to transmit a notification to a first user device associated with the first user comprising the modified initial payment.

11. The apparatus according to claim 8, wherein the alternative funding circuitry is further configured to:
obtain the first payment attribute data associated with the first user from a payment attribute database;
compare the first payment attribute data with one or more first user payment risk thresholds; and
select at least the first non-cash liquid asset from amongst the first payment attribute data as the first alternative payment data in an instance in which the first payment attribute data satisfies the first user payment risk thresholds.

12. (canceled)

13. The apparatus according to claim 11, wherein the alternative funding circuitry is further configured to:
identify a second transaction associated with a second user;
obtain second payment attribute data associated with the second user from the payment attribute database;
compare the second payment attribute data with one or more second user payment risk thresholds; and
select at least a second non-cash liquid asset associated with the second user from amongst the second payment attribute data as second alternative payment data in an instance in which the second payment attribute data satisfies the second user payment risk threshold.

14. The apparatus according to claim 13, wherein the alternative funding circuitry is further configured to adapt the modified initial payment transaction based upon the second alternative payment data.

15. A non-transitory computer-readable storage medium for alternative payment transactions, the non-transitory computer-readable storage medium storing instructions that, when executed, cause an apparatus to:
receive a first request for payment associated with a first transaction, wherein the first request for payment comprises one or more first payment parameters;
generate an initial payment responsive to the first request for payment based upon the first payment parameters;
determine first alternative payment data based upon first payment attribute data of a first user associated with the first transaction, wherein the first payment attribute data is associated with non-cash liquid assets of the first user and the first payment attribute data provides one or more instructions regarding the selection of non-cash liquid assets associated with the first user; and
modify the initial payment based upon the first alternative payment data, wherein modifying the initial payment comprises selection of at least a first non-cash liquid asset as defined by the first payment attribute data; and
effectuate the modified initial payment by transferring ownership of flail the at least first non-cash liquid asset directly to an entity associated with the request for payment in satisfaction of the first transaction.

16. (canceled)

17. The non-transitory computer-readable storage medium according to claim 15 storing instruction that, when executed, cause the apparatus to transmit a notification to a first user device associated with the first user comprising the modified initial payment.

18. The non-transitory computer-readable storage medium according to claim 15 storing instruction that, when executed, cause the apparatus to:
obtain the first payment attribute data associated with the first user from a payment attribute database;
compare the first payment attribute data with one or more first user payment risk thresholds; and
select at least the first non-cash liquid asset from amongst the first payment attribute data as the first alternative payment data in an instance in which the first payment attribute data satisfies the first user payment risk thresholds.

19. The non-transitory computer-readable storage medium according to claim 18 storing instruction that, when executed, cause the apparatus to:
identify a second transaction associated with a second user;
obtain second payment attribute data associated with the second user from the payment attribute database;
compare the second payment attribute data with one or more second user payment risk thresholds; and
select at least a second non-cash liquid asset associated with the second user from amongst the second payment attribute data as second alternative payment data in an instance in which the second payment attribute data satisfies the second user payment risk threshold.

20. The non-transitory computer-readable storage medium according to claim 19 storing instruction that, when executed, cause the apparatus to adapt the modified initial payment transaction based upon the second alternative payment data.

21. The computer-implemented method according to claim 1, wherein the transfer of ownership of the first non-cash liquid asset comprises a direct transfer of ownership from the first user to an entity associated with the request for payment.

22. The computer-implemented method according to claim 1, wherein the transfer of ownership of the first non-cash liquid asset comprises a direct transfer of ownership from a first account of the first user to an account of an entity associated with the request for payment.

23. The computer-implemented method according to claim 1, wherein determining the first alternative payment data further comprises supplying the first payment attribute data of the first user to a machine learning model such that the first alternative payment data is determined based upon operation of the machine learning model.

24. The computer-implemented method according to claim 1, wherein the transfer of ownership of the first non-cash liquid asset comprises a direct transfer of a fractional ownership of the first non-cash liquid asset from the first user to an entity associated with the request for payment.

25. The computer-implemented method according to claim 1, further comprising modifying the first payment attribute data to remove ownership of the first non-cash liquid asset by the first user.
